(19) United States
(12) Patent Application Publication
(10) Pub. No.: US 2026/0285700 A1
(43) Pub. Date: Sep. 24, 2026

(54) RECOVERY OF LITHIUM FROM BLACK MASS

(71) Applicant: Metso Finland Oy, Espoo (FI)

(72) Inventor: Roshan Budhathoki, Espoo (FI)

(73) Assignee: METSO FINLAND OY, Espoo (FI)

(21) Appl. No.: 19/490,042

(22) PCT Filed: Jun. 3, 2024
(86) PCT No.: PCT/FI2024/050288

§ 371 Date: Dec. 4, 2025

(30) Foreign Application Priority Data
Jun. 5, 2023 (FI) 20235624

(51) Int. Cl. C01F 7/78; C01G 53/01; C22B 3/00; C22B 3/22; C22B 3/44; C22B 7/00; C22B 15/00; C22B 26/12; C22B 47/00; H01M 10/54

(52) U.S. Cl. CPC C01F 7/78; C01G 53/01; C22B 3/22; C22B 3/44; C22B 7/007; C22B 15/0067; C22B 23/0453; C22B 26/12; C22B 47/00; H01M 10/54

(57) ABSTRACT

A method for recovering one or more metals including lithium from a leach solution originating from spent lithium-containing batteries. The method includes the steps of adjusting the pH of the lithium containing leach solution to a level of <7, adding one or more of aluminium, fluorine and lithium reagents to the acidified solution, as needed to make all these reagents available, adjusting the stoichiometric balance of the reaction mixture, and recovering the precipitated lithium cryolite from the solution of the reaction mixture.

### FIELD

The present invention relates to a method for recovering one or more metals from battery material, particularly for extracting lithium from a leach solution originating from spent batteries, followed by optional further extractions.

### BACKGROUND

The use of lithium-ion batteries has grown steadily for the last years, and their importance appears to grow even further in the upcoming years. Lithium-ion batteries contain, in their cathodes, several transition metals that can be valuable when recovered from these batteries, either for reuse in new batteries or for other purposes. Particularly the lithium of these materials is valuable for recovery and reuse.

Hydrometallurgical separations of metals from lithium-ion batteries proceed via the recovery of a black mass, which contains cathode metals and anode material, but from which wiring and other coarse solid battery components, such as plastic or steel parts, have already been removed.

The next step is typically the separation of the cathode metals from the other components of the black mass, e.g. using mechanical, thermal or chemical pre-treatment steps, followed by acid leaching to solubilize the cathode metals, and prepare them for recovery.

After leaching, the desired metals can be recovered. WO 2022/219223 A1 describes a method for recovering lithium and other metals from a leach solution obtained from battery black mass. In this method the lithium recovery is, however, preceded by other separations and recoveries.

Since each step of such a process poses a risk for metal losses, each step preceding the lithium recovery will cause further losses of lithium. However, the present inventors have now found a new procedure for recovering metals from the battery black mass, which reduces lithium losses.

### SUMMARY OF THE INVENTION

The invention is defined by the features of the independent claims. Some specific embodiments are defined in the dependent claims.

According to a first aspect of the present invention, there is provided a method for recovering one or more metals from spent batteries.

According to a second aspect of the invention, there is provided a method for recovering one or more metals including lithium (Li) from the black mass obtained from spent lithium-containing batteries.

According to a further aspect, there is provided a method aiming at increasing the yield of lithium in the recovery of metals from a black mass leach solution.

The present invention thus relates to a method for recovering one or more metals, including lithium, from a leach solution originating from spent lithium-containing batteries, the method including the steps of adjusting the pH of the lithium containing leach solution to a level of <7, adding one or more of aluminium (Al), fluorine (F) and lithium (Li) reagents to the acidic solution, as needed to make all these reagents available, and to adjust the stoichiometric balance of the reaction mixture, and to precipitate lithium cryolite, and recovering the precipitated lithium cryolite from the reaction mixture.

The invention focuses on the precipitation of lithium at a low pH regime (less than 2) to obtain lithium cryolite (Li₃AlF₆). The lithium recovery takes place after the black mass of the battery material has been leached, e.g. using an acidic leach solution containing sulphuric acid, and a leach solution containing the cathode metals has been obtained, but before any other metals have been recovered.

The concentration of lithium in the leach solution used as a starting material typically varies in the range of 4-8 g/l. Some aluminium (Al) and fluorine (F) may also be present, but by adjusting the stoichiometric balance of the acidified leach solution, by adding further Al, F and/or Li reagents, as needed, to match the lithium cryolite stoichiometry, the cryolite can be precipitated from the solution. The key step for the precipitation is to have the stoichiometric ratio or higher dose of Al and F. When this minimum stoichiometry is reached, and the pH is at a sufficiently low level, the lithium is selectively precipitated as Li₃AlF₆. The precipitation efficiency is typically at a level of 80-90%.

The precipitation can also take place at higher pH levels, such as in CN 113684369 A, but this would lead to losses in selectivity and purity, as impurities will also be precipitated.

Several advantages are achieved with the help of the present invention. Particularly, losses of lithium taking place with conventional methods are avoided, whereby a high selectivity in lithium recovery is achieved, and a high-purity lithium product can be obtained with a high yield.

Further, when purifying the lithium product obtained using the method of the invention a battery-grade product will be obtained, which can be recirculated back to use in preparing cathodes for lithium-containing batteries.

### BRIEF DESCRIPTION OF THE DRAWINGS

FIG. 1 illustrates an arrangement for recovering lithium cryolite from a leach solution originating from spent lithium-containing batteries in accordance with at least some embodiments of the present invention.

### EMBODIMENTS

### Definitions

In the present context, the “lithium-containing batteries” are typically NMC or LFP batteries, the invention being particularly suitable for use in recovering metals from NMC batteries but is also suitable for use in recovering metals from LFP batteries.

The invention thus focuses on the recycling and recovery of metals, such as lithium (Li), from a black mass leach solution originating from lithium-containing batteries. These batteries can be of the NMC (or LFP) type. In addition to lithium, it is of particular advantage to recover other battery metals from these, such as nickel (Ni), cobalt (Co), and manganese (Mn), as well as other components of the black mass, such as copper (Cu), aluminium (Al), iron (Fe), and fluorine (F).

“NMC” batteries have a cathode formed using mixed metal oxides of lithium, nickel, manganese and cobalt.

“LFP” batteries, in turn, use lithium iron phosphate (lithium ferro-phosphate) as the cathode.

The invention thus relates to a method for recovering one or more metals including lithium from a leach solution originating from spent lithium-containing batteries, including the steps of
adjusting the pH of the lithium containing leach solution to a level of <7,
adding one or more of aluminium (Al), fluorine (F) and lithium (Li) reagents to the acidic solution, as needed to make all these reagents available, and to adjust the stoichiometric balance of the reaction mixture, and to precipitate the lithium cryolite, and
recovering the precipitated lithium cryolite from the solution of the reaction mixture.

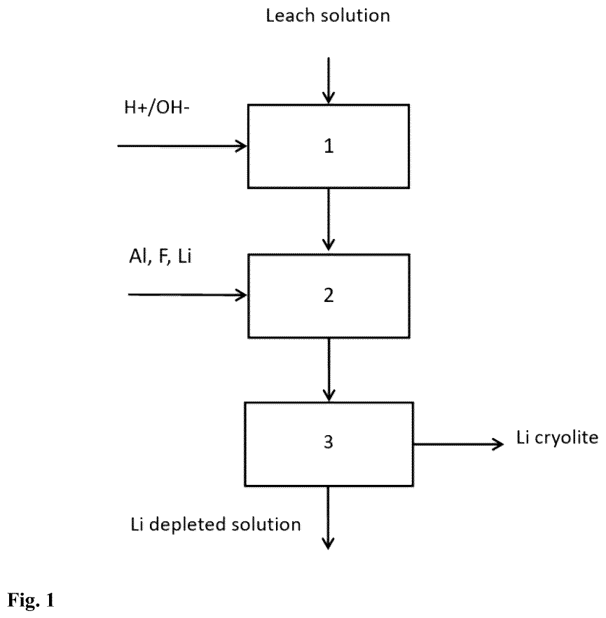

The invention can be carried out for example in an arrangement shown in FIG. 1, which includes a pH adjustment unit 1 with an inlet for the leach solution and an inlet for pH adjustment reagent, such as acid or alkali, a reaction unit 2 with an inlet for Al, F and/or Li reagents, for adjusting the stoichiometric balance of the reaction mixture to favour cryolite formation, and a recovery unit 3, for recovering the lithium cryolite e.g. by precipitation, the recovery unit 3 including an outlet for the cryolite and a separate outlet for lithium depleted solution.

Typically, the leach solution used as the starting material in the method originates from the black mass of such lithium-containing batteries, which contains cathode metals and anode material, but from which wiring and other coarse solid battery components, such as plastic or steel parts, have already been removed.

In an embodiment of the invention, the leach solution originates from the black mass obtained from NMC batteries including, in addition to lithium metal, also one or more additional metal, such as nickel (Ni), cobalt (Co), or manganese (Mn), or copper (Cu) and typically one or more impurity, such as iron (Fe), aluminium (Al) or fluorine (F).

The leach solution is preferably obtained from a leaching that has taken place in acidic conditions, using a leach solution containing sulphuric acid, whereby the pH of the leach solution is already at or close to the desired acidic level before the pH adjustment of the present invention is carried out. Optionally, the leaching has been carried out using further redox chemicals, such as hydrogen peroxide, carbohydrates and sulphur dioxide, due to their reductive capabilities, providing a more effective dissolution.

Before the precipitation of the lithium, the pH of the leach solution used as starting material is adjusted to an acidic level, preferably to a level of ≤4, such as 0.5-4, more preferably 1-2, and most suitably to a level that extends from 1.5 to less than 2. Preferably, the pH is adjusted using an alkaline solution containing for example ammonium hydroxide, NaOH, KOH, Na₂CO₃, CaCO₃, Ca(OH)₂, or an acidic solution containing an inorganic acid such as sulphuric acid (H₂SO₄) or hydrochloric acid (HCl), or a solution containing a suitable combination of such agents, providing the desired alkalinity or acidity for pH adjustment. Since the leach solution used as a starting material typically already contains sulphuric acid, sulphuric acid is a preferred alternative to use in the pH adjustment.

To facilitate an efficient lithium precipitation, the contents of lithium (Li), aluminium (Al), and fluorine (F) of the leach solution is determined either before or after the pH adjustment, and if needed, one or more of these components are made available by adding Al, F and Li reagents to the solution. Preferably, sufficient amounts of these reagents are added to the acidified leach solution to provide a stoichiometry of Li:Al:F of 3:0.8-2:5.5-8, more preferably to provide a stoichiometry of Li:Al:F of about 3:1:6.

The reagents used for adjusting the stoichiometry in the acidified leach solution are preferably selected from fluorine-containing compounds, such as ammonium fluoride or hydrofluoric acid, or aluminium-containing salts such as aluminium sulphate, or lithium-containing compounds, such as lithium sulphate, lithium chloride, lithium fluoride.

After the adjustment of the contents of Li, Al and F in the acidified leach solution to reach said pre-determined stoichiometry, the lithium is precipitated as the cryolite. The precipitation is allowed to proceed at a temperature from 5 to 100° C., preferably from 10 to 95° C. or 10 to 90° C., more preferably from 20 to 80° C. or, even more preferably from 40 to 70° C. or, even more preferably from 60 to 70° C. Likewise, the precipitation is preferably carried out at atmospheric pressure, or at least close to atmospheric pressure, such as at a pressure of 0.5-5 bar, preferably at a pressure of 1-5 bar.

The precipitate is preferably recovered from the remaining solution, i.e. from the solution of the reaction mixture, by solid-liquid separation, such as by filtration, thickening or a combination thereof.

In an embodiment of the invention, the lithium cryolite obtained as a precipitate is reacted further into lithium hydroxide through an alkaline process, and is recovered as monohydrate crystals.

In an embodiment of the invention, the solution remaining after the lithium cryolite recovery, is carried to one or more steps for separating one or more of the impurities Al, Fe and F from the solution. These impurity separations are preferably carried out by precipitation, such as a hydroxide precipitation that provides a precipitate of iron and aluminium, or by solvent extraction, or by a precipitation and filtration of any solid impurities followed by a solvent extraction.

In another embodiment of the invention, the solution remaining after the lithium cryolite recovery, is carried to one or more further recovery steps, for recovering one or more of the metals Ni, Co, Mn and Cu, these steps preferably being carried out after the optional impurity separations mentioned above.

In case a copper recovery is carried out, it preferably takes place before the Ni, Co and Mn are recovered, since copper can have a negative impact on these subsequent recoveries and on product qualities. The copper recovery can be carried out e.g. as a solvent extraction (SX), or as a precipitation, such as a hydroxide precipitation, or as a precipitation followed by a solvent extraction or as a cementation using nickel as the reagent, which results in a replacement of the Cu in solution with Ni, thus giving a Cu metal product, which can easily be separated from the components of the solution. The cementation reaction is based on the nickel reagent having a higher, or more negative, reduction potential (−0.25 V) than the reduction potential of copper (0.34 V). The selectivity of the nickel reagent is, in turn, partly based on the fact that the reduction potentials of the other elements present in the leach solution, such as the cobalt (−0.28 V), manganese (−1.19 V) or aluminium (−1.66), are more negative than that of the nickel reagent, whereby these other elements will not be reduced.

In case a nickel recovery is carried out on the leach solution, it preferably takes place after the separation of the copper, and more preferably either simultaneously with or directly after the optional recovery of cobalt, most suitably after the cobalt is recovered. Similarly, it is preferred to carry out the nickel recovery after an optional manganese recovery.

Said optional nickel recovery can be carried out, for example using a solvent extraction (SX), which produces a rather pure nickel sulphate solution (NiSO₄). This solution is optionally purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for nickel recovery is most suitably carried out using extraction chemicals having a carboxylic acid functional group, one commercial example of suitable extraction chemicals being Versatic™ 10, which is a neodecanoic acid.

In case a cobalt recovery is carried out, it preferably takes place either simultaneously with or directly before the recovery of nickel, more preferably before the nickel is recovered. Similarly, it is preferred to carry out the cobalt recovery after an optional manganese removal or recovery.

A preferred option for said optional cobalt recovery is a solvent extraction (SX), which produces a rather pure cobalt sulphate solution (CoSO₄). This solution can be purified further, e.g. by ion exchange (IX), after which a crystallization can be carried out, or a precipitation into a hydroxide or a carbonate, or the sulphate solution can be used as such, without crystallization or precipitation, e.g. in the preparation of new cathode materials. The optional solvent extraction for cobalt recovery is most suitably carried out using extraction chemicals having a carboxylic acid functional group, such as the phosphinic acid functional group, one example of suitable extraction chemicals being Cyanex™ 272, which is also known as trihexyltetradecylphosphonium bis(2,4,4-trimethylpentyl)phosphinate.

In one alternative manner of proceeding with the metal recoveries, as indicated above, cobalt and nickel can be recovered simultaneously from the leach solution, for example by a solvent extraction, thus producing a sulphate solution, optionally followed by a further purification by ion exchange (IX), or a precipitation into the hydroxides or the carbonates. Alternatively, the sulphate solution can be used as such, without crystallization or precipitation, e.g. in the preparation of new cathode materials.

In case a separate recovery of manganese is carried out, it preferably takes place before any recovery of nickel or cobalt.

Options for a manganese recovery include solvent extractions, precipitations and crystallizations, or a solvent extraction followed by a precipitation or crystallization. One particularly preferred option is to utilize an oxidative precipitation using sulphur dioxide, SO₂, and air, to form the manganese oxide, MnO₂.

As a conclusion, the present invention is useful for recovering all of the valuable metals of the cathodes of spent lithium batteries in high yields and with high selectivities. Particularly, the selectivity of the lithium recovery has been improved, as compared to existing technical solutions.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. Numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also unrecited features. The features recited in depending claims are mutually freely combinable unless otherwise explicitly stated. Furthermore, it is to be understood that the use of “a” or “an”, i.e. a singular form, throughout this document does not exclude a plurality.

### INDUSTRIAL APPLICABILITY

The present method can be used to replace conventional alternatives for recovery of metals from the black mass obtained from lithium-ion batteries.

In particular, the method provides an economical and efficient procedure for recovering lithium and optional further metals in good yields from such battery material. The yield of lithium is particularly increased by carrying out said recovery before any further metal recoveries

### CITATION LIST

### Patent Literature

CN 113684369 A
WO 2022/219223 A1

### EXAMPLES

Black mass was dissolved with a suitable inorganic acid and lixiviants to obtain a leach solution, which consists of valuable metals such as Li, Ni, Co, Cu, Mn, etc. The thus obtained leach solution was used to carry out lithium precipitation tests. One liter of leach solution was taken into a reactor. The temperature was adjusted to the target value, and the stoichiometric ratio of Li:Al:F was adjusted by adding suitable reagents containing Li, Al and/or F. Then, the pH was adjusted accordingly, and corresponding samples were taken after one hour of residence time to determine the remaining concentration of the metal ion in the solution. The following examples show the effects of temperature, pH and stoichiometric ratio of Li:Al:F on lithium and aluminium yields.

### Example 1

In Example 1 temperature and pH were kept constant (T=80° C. and pH=1.5) and stoichiometric ratio of Li:Al:F was varied.

TABLE 1
The effect of Li:Al:F ratio to Li and Al yields

| | | | | | | | Al | | |
|---|---|---|---|---|---|---|---|---|---|
| | | | | Li concentration | | Li | concentration | | Al |
| | T | Stoichiometric | | (mg/l) | | Yield | (mg/l) | | Yield |
| Test | (° C.) | ratio (Li:Al:F) | pH | Starting | Final | % | Starting | Final | % |
| 3a | 80 | 3:0.9:4.2 | 1.50 | 8360 | 4160 | 50.24 | 9670 | 3890 | 59.77 |
| 3b | 80 | 3:0.9:4.8 | 1.50 | 8360 | 3050 | 63.52 | 9670 | 2380 | 75.39 |
| 4a | 80 | 3:0.9:5.6 | 1.50 | 8360 | 2690 | 67.82 | 9670 | 1330 | 86.25 |
| 3c | 80 | 3:0.9:6.0 | 1.50 | 8360 | 2010 | 75.96 | 9670 | 1520 | 84.28 |
| 2c | 80 | 3:0.9:7.2 | 1.50 | 8360 | 1390 | 83.37 | 9670 | 824 | 91.48 |

It can be seen from Table 1 that it is favourable to use slight excess of F when precipitating Li. The highest Li yield was obtained when fluoride reagent was used at excess of 1.2 factor.

### Example 2

In Example 2, the stoichiometric ratio of Li:Al:F and the pH were kept constant (Li:Al:F=3:0.9:7.2 and pH=1.5) and the temperature was varied.

TABLE 2
The effect of temperature to Li and Al yields

| | | | | | | | Al | | |
|---|---|---|---|---|---|---|---|---|---|
| | | | | Li concentration | | Li | concentration | | Al |
| | T | Stoichiometric | | (mg/l) | | Yield | (mg/l) | | Yield |
| Test | (° C.) | ratio (Li:Al:F) | pH | Starting | Final | % | Starting | Final | % |
| 2a | 65 | 3:0.9:7.2 | 1.50 | 8360 | 1150 | 86.24 | 9670 | 378 | 96.09 |
| 2b | 75 | 3:0.9:7.2 | 1.50 | 8360 | 1310 | 84.33 | 9670 | 789 | 91.84 |
| 2c | 80 | 3:0.9:7.2 | 1.50 | 8360 | 1390 | 83.37 | 9670 | 824 | 91.48 |

It can be seen from Table 2 that the highest Li yield was obtained at 65° C.

### Example 3

In Example 3, the temperature and the stoichiometric ratio of Li:Al:F were kept constant (T=80° C. and Li:Al:F=3:0.9:5.6) and the pH was varied.

TABLE 3
The effect of pH to Li and Al yields

| | | | | | | | Al | | |
|---|---|---|---|---|---|---|---|---|---|
| | | | | Li concentration | | Li | concentration | | Al |
| | T | Stoichiometric | | (mg/l) | | Yield | (mg/l) | | Yield |
| Test | (° C.) | ratio (Li:Al:F) | pH | Starting | Final | % | Starting | Final | % |
| 4a | 80 | 3:0.9:5.6 | 1.50 | 8360 | 2690 | 67.82 | 9670 | 1330 | 86.25 |
| 4a | 80 | 3:0.9:5.6 | 1.75 | 8360 | 4680 | 44.02 | 9670 | 623 | 93.56 |
| 4a | 80 | 3:0.9:5.6 | 2.00 | 8360 | 4530 | 45.81 | 9670 | 314 | 96.75 |
| 4a | 80 | 3:0.9:5.6 | 2.25 | 8360 | 3940 | 52.87 | 9670 | 248 | 97.44 |

It can be seen from Table 3 that the highest Li yield was obtained at pH 1.5.

### CONCLUSION

In a typical Li battery recycling process, the lithium recovery process steps take place at the end of the process. For example, when black mass is leached with a suitable acid and lixiviants, impurities are removed in the pH range 3-4, battery metals are recovered at pH 4-6, and at last lithium is recovered as lithium-carbonate, phosphate, or hydroxide in pH range of >10. During this process, significant amount of Li may be due lost during the preceding process steps resulting in lower Li yield from the overall process. The method described herein tackles this challenge by precipitating lithium as cryolite in pH as low as 1.5 by adjusting the stoichiometric ratio of Li:Al:F. Lithium recovery can be carried out at higher pH but the risk of Fe, Ni, Co co-precipitation increases at higher pH. Hence, lower pH of 1.5 is optimal for selective recovery of Li from the black mass leach solution. Since, the solubility of lithium in the tested region lies in the range of 1100-1600 mg/l, lithium recovery yield also depends on its initial concentration.

1-14. (canceled)

15. A method for recovering one or more metals including lithium from a leach solution originating from spent lithium-containing batteries, comprising the steps of:
adjusting the pH of the lithium containing leach solution to a level of <7;
adding one or more of aluminium (Al), fluorine (F) and lithium (Li) reagents to the acidic solution, as needed to make all these reagents available, and to adjust the stoichiometric balance of the reaction mixture; and
recovering the precipitated lithium cryolite from the solution of the reaction mixture, wherein the solution remaining after lithium cryolite recovery is carried to one or more steps of metal recovery for recovering one or more of the metals Ni, Co, Mn and Cu.

16. The method of claim 15, wherein the leach solution originates from the black mass obtained from lithium-containing batteries.

17. The method of claim 15, wherein the leach solution originates from the black mass obtained from NMC batteries including, in addition to lithium metal, also one or more additional metal, such as nickel (Ni), cobalt (Co), manganese (Mn) or copper (Cu) and one or more impurity such as iron (Fe), aluminium (Al) or fluorine (F).

18. The method of claim 15, wherein the pH of the leach solution is adjusted to a level of ≤4, preferably 0.5-4, more preferably 1-2, most suitably from 1.5 to less than 2.

19. The method of claim 15, wherein the pH adjustment of the leach solution is carried out using an alkaline solution containing for example ammonium hydroxide, NaOH, KOH, or an acidic solution containing an inorganic acid such as sulphuric acid (H₂SO₄) or hydrochloric acid (HCl), or a solution containing a suitable combination of such agents, providing the desired alkalinity or acidity for pH adjustment.

20. The method of claim 15, wherein the Li, Al, and F contents of the leach solution is determined either before or after the pH adjustment, and Al, F and Li reagents are added to the solution, as needed, to provide a stoichiometry of Li:Al:F of 3:0.8-2:5.5-8, preferably to provide a stoichiometry of Li:Al:F of about 3:1:6.

21. The method of claim 15, wherein the Al, F and Li reagents are selected from fluorine-containing compounds, such as ammonium fluoride or hydrofluoric acid, or aluminium-containing salts such as aluminium sulphate, or lithium-containing compounds, such as lithium sulphate, lithium chloride, lithium fluoride.

22. The method of claim 15, wherein the lithium cryolite obtained as a precipitate is separated from the remaining solution by a solid-liquid separation, preferably carried out as a filtration.

23. The method of claim 15, wherein the lithium cryolite obtained as a precipitate is reacted further into lithium hydroxide through an alkaline process, and is recovered as monohydrate crystals.

24. The method of claim 15, wherein the solution remaining after lithium cryolite recovery is carried to one or more steps for separating one or more of the impurities Al, Fe and F from the solution, preferably carried out by precipitation.

25. The method of claim 15, wherein the solution remaining after lithium cryolite recovery is carried to one or more steps of metal recovery, taking place after one or more steps of impurity separation.

26. The method of claim 15, wherein the solution remaining after lithium cryolite recovery is carried to a copper recovery, preferably carried out as a solvent extraction (SX), or as a precipitation, such as a hydroxide precipitation, or as a precipitation followed by a solvent extraction or as a cementation using nickel as reducing agent, or as a solvent extraction followed by a cementation.

27. The method of claim 15, wherein the solution remaining after lithium cryolite recovery, optionally deprived of copper, is carried to one or more steps for recovering nickel and cobalt, either separately or as a mixture, preferably using one or more steps of solvent extraction.

28. The method of claim 15, wherein the solution remaining after lithium cryolite recovery, optionally deprived of one or more of copper, nickel and cobalt, is carried to a manganese recovery, preferably carried out as a solvent extraction or as a precipitation or a crystallization, or as a solvent extraction followed by a precipitation or crystallization.
